(19) United States
(12) Patent Application Publication
(10) Pub. No.: US 2013/0018907 A1
(43) Pub. Date: Jan. 17, 2013

(54) Dynamic Subsumption Inference

(71) Applicants: Lukas D. Kuhn, San Diego, CA (US); Siddharth S. Taduri, San Diego, CA (US); Vidya Narayanan, San Diego, CA (US); Fuming Shih, San Diego, CA (US)

(72) Inventors: Lukas D. Kuhn, San Diego, CA (US); Siddharth S. Taduri, San Diego, CA (US); Vidya Narayanan, San Diego, CA (US); Fuming Shih, San Diego, CA (US)

(73) Assignee: QUALCOMM Incorporated, San Diego, CA (US)

(21) Appl. No.: 13/547,902

(22) Filed: Jul. 12, 2012

Related U.S. Application Data
(60) Provisional application No. 61/507,934, filed on Jul. 14, 2011.

(51) Int. Cl. G06F 17/30

(52) U.S. Cl. 707/758; 707/E17.009

(57) ABSTRACT

Systems and methods for Dynamic Subsumption Inference are disclosed. For example, a method for Dynamic Subsumption Inference, may include: receiving a time signal associated with the current time; receiving a first input signal comprising data associated with a user at the current time; determining a first context based on the first input signal and the current time; comparing the first context to a database of contexts associated with the user; and determining a second context based in part on the comparison.

### CROSS REFERENCE TO RELATED APPLICATIONS

This patent application claims priority to U.S. Provisional Application No. 61/507,934, titled “Dynamic Subsumption Inference,” filed on Jul. 14, 2011, the entirety of which is hereby incorporated by reference.

### FIELD OF THE INVENTION

The present invention generally relates to interpretations of data, and in particular learning algorithms associated with user data.

### BACKGROUND

Machine interpretations of data are different from how a human may perceive that data. A machine learning algorithm may identify situations or places based on data such as SPS, accelerometer, WiFi, or other signals. The labels that a machine assigns to the location or situation associated with these signals need to be modified to match labels meaningful to the user.

### SUMMARY

Embodiments of the present disclosure provide systems and methods for Dynamic Subsumption Inference. For example, in one embodiment, a method for Dynamic Subsumption Inference comprises, receiving a time signal associated with the current time; receiving a first input signal comprising data associated with a user at the current time; determining a first context based on the first input signal and the current time; comparing the first context to a database of contexts associated with the user; and determining a second context based in part on the comparison.

These illustrative embodiments are mentioned not to limit or define the disclosure, but to provide examples to aid understanding thereof. Illustrative embodiments are discussed in the Detailed Description, and further description of the disclosure is provided there. Advantages offered by various embodiments of this disclosure may be further understood by examining this specification.

### BRIEF DESCRIPTION OF THE DRAWINGS

FIG. 1 is a block diagram of components of a mobile device according to one embodiment;

FIG. 2 is a block diagram of a system that is operable to perform a dynamic subsumption inference;

FIG. 3a is a diagram of the difference between a user's perspective and a machine perspective of a location;

FIG. 3b is another diagram of the difference between a user's perspective and a machine perspective of a location;

FIG. 4a is a diagram of tags applied to signals based on location data;

FIG. 4b is a diagram of a subsumption determination based on tags;

FIG. 5a is a diagram of signals available at a specific location;

FIG. 5b is a diagram of a dynamic subsumption inference according to one embodiment;

FIG. 6a is another diagram of a dynamic subsumption inference according to one embodiment;

FIG. 6b is another diagram of a dynamic subsumption inference according to one embodiment; and

FIG. 7 is a flow chart for a method for dynamic subsumption inference according to one embodiment.

### DETAILED DESCRIPTION

Embodiments of the present disclosure provide systems and methods for implementing a dynamically evolving model that can be refined when new information becomes available. This information may come in the form data received in response to a user prompt or data received from a sensor, for example, a Satellite Positioning Signal (“SPS”) signal, Wi-Fi signal, a response to a user prompt, or a signal received from a motion sensor or other sensor.

When a device according to the present disclosure receives new information, it combines this new information with other available information about the user, for example, past sensor data or responses to past prompts. This enables a device according to the present disclosure to develop a model that grows and adapts as new data is received.

As described herein, data about the user is referred to as context. Context is any information that can be used to characterize the situation of an entity. In some embodiments context may be associated with variables relevant to a user and a task the user is accomplishing. For example, in some embodiments, context may be associated with the user's location, features associated with the present location (e.g. environmental factors), an action the user is currently taking, a task the user is attempting to complete, the user's current status, or any other available information. In some embodiments, context may be associated with a mobile device or application. For example, in some embodiments, context may be associated with a specific mobile device or specific application. For example, in some embodiments, context may be associated with a mobile application, such as a social networking application, a map application, or a messaging application. Further examples of contexts include information associated with location, times, activities, current sounds, and other environmental factors, such as temperature, humidity, or other relevant information.

In some embodiments, context or contexts may be determined from sensors, for example physical sensors such as accelerometers, SPS and WiFi signals, light sensors, audio sensors, biometric sensors, or other available physical sensors known in the art. In other embodiments, context may be determined by information received from virtual sensors, for example, one or more sensors and logic associated with those sensors. In one embodiment, a virtual sensor may comprise a sensor that uses SPS, wi-fi, and time sensors in combination with programming to determine that the user is at home. In some embodiments, these sensors, and the associated programming and processor may be part of a single module, referred to as a sensor.

Context information gathered from sensors may be used for a variety of purposes, for example to modify operation of the mobile device or provide relevant information to the user. But a machine, for example, a mobile device, does not perceive information in the same way that a human may perceive information. The present disclosure describes systems and methods for associating human level annotations with machine readable sensor data. For example, some embodiments of the present disclosure contemplate receiving sensor data, comparing that sensor data to a database of data associated with the user, and making determinations about the user based on the comparison. These determinations may then be used to modify operation of a device or direct specific useful information to the user.

In one embodiment of the present disclosure, sensor data associated with a user may be received by a mobile device (or context engine) and used to determine information about the user's current context. In some embodiments, this determination may be made based at least in part on data associated with the user's past context or contexts. For example, in one embodiment a sensor may detect data associated with the user's present location and transmit that data to a context engine. In such an embodiment, based on that sensor data, the context engine may determine that the user is at home. Similarly, in another embodiment, the context engine may receive additional data, for example, the user's current physical activity, and based on this data make additional determinations. In still other embodiments, the context engine may receive multiple sensor signals. In one such embodiment, one sensor signal may indicate that the user is currently at home and another indicating that the user is sleeping. In such an embodiment, the context engine may compare this information to past user contexts, and determine that the user is in bed. Or, in another embodiment, the context engine may receive further sensor data, for example, from a time sensor, indicating that the current time is 4 PM. In such an embodiment, the system may then compare this additional data to a database and determine that, based on past contexts, the user is not in bed, but rather is sleeping on a couch in the user's living room. Such a determination introduces the concept of subsumption, in which one larger context, e.g. home, comprises multiple smaller contexts, e.g. bedroom, kitchen, and living room.

In further embodiments of the present disclosure the context engine may determine the context based at least in part on user input. For example, a context engine may be configured to generate a user interface to receive user input related to context, and in response to signals generated by user input may determine addition information associated with a user's current context. For example, in one embodiment, the context engine may display prompts to which the user responds with answers regarding the user's current situation. For example, in some embodiments, these prompts may comprise prompts such as “are you at work,” “are you eating,” or “are you currently late,” may be used to determine additional information about the user's current context.

In some embodiments of the present disclosure, the context engine may receive user input from other interfaces or applications, for example, social networking pages or posts, text messages, emails, calendar applications, document preparation software, or other applications configured to receive user input. For example, a context engine may be configured to access a user's stored calendar information. In one such embodiment, a user may have stored data associated with a dentist appointment at 8 AM. Based on sensor data, the context engine may determine that the current time is 8:10 AM and that the user is currently travelling 50 miles per hour. Based on this information, the context engine may determine that the user is currently late to the dentist appointment. The system may further reference additional sensor data, for example, SPS data showing the user's current location to determine that the user is in route to the dentist appointment. In a further embodiment, the system may receive additional sensor data that the user is at the dentist.

Further, in some embodiments of the present disclosure, a context engine may apply context information to a database associated with the user. In some embodiments, the context engine may be configured to access this database to make future determinations about the user's context. For example, in one embodiment, a database may store a context associated with walking to work at a specific time on each weekday. Based on this data, the context engine may determine that at that the specific time, the user is walking to work, or should be walking to work.

In an embodiment of the disclosure a system may use context data for a multitude of purposes. For example, in one embodiment, a context engine may use context data to selectively apply reminders, change the operation of a mobile device, direct specific marketing, or some other function. For example, in the embodiment described above with regard to the user who is late to a dentist appointment, based on context information the context engine may determine that the user is late and generate a reminder to output to the user. Further, in one embodiment, the context engine may identify the user's current location and generate and output a display showing the user the shortest route to the dentist. Or in another embodiment, the device may generate a prompt showing the user the dentist's phone number so the user can call to reschedule the appointment. Similarly, in some embodiments, if the user arrives at the dentist on time, the context engine may use context data to determine that the calendar reminder should be deactivated, so the user is not bothered.

In other embodiments, context information may be used for other purposes. In one embodiment, a context engine may receive sensor data that indicates there is a high probability a user is in a meeting, for example, based on SPS data that the user is in the office, the current time of day, and an entry in the user's calendar associated with “meeting.” Thus, a system according to the present disclosure may adjust the device settings of the user's mobile device to set the ringer to silent, so the user is not disturbed during the meeting. Further, in some embodiments, this information may be used for direct marketing. For example, in some embodiments, mobile advertising may be directed to the user based on the user's current location and activity. For example, in one such embodiment, a system of the present disclosure may determine that the user is likely hungry. In such an embodiment, the context engine may make this determination based on input data associated with the current time of day and past input regarding when the user normally eats. Based on this context, a context engine of the present disclosure may output web pages associated with restaurants to the user. In a further embodiment of the present disclosure, the context engine may determine a context associated with the user's current location and output marketing related to nearby restaurants. In a further embodiment, the system may determine a context associated with restaurants for which the user has previously indicated a preference and provide the user with information associated with only those restaurants.

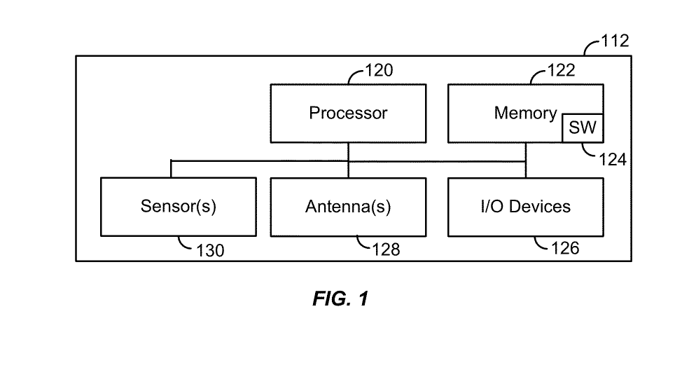

Referring now to the drawings, in which like numerals indicate like elements throughout the several figures, FIG. 1, shows an example 112 of a mobile device, which comprises a computer system including a processor 120, memory 122 including software 124, input/output (I/O) device(s) 126 (e.g., a display, speaker, keypad, touch screen or touchpad, etc.), sensors 130, and one or more antennas 128. The antenna(s) 128 provide communication functionality for the device 112 and facilitates bi-directional communication with the base station controllers (not shown in FIG. 1). The antennas may also enable reception and measurement of satellite positioning system (“SPS”) signals—e.g. signals from SPS satellites (not shown in FIG. 1). The antenna(s) 128 can operate based on instructions from a transmitter and/or receiver module, which can be implemented via the processor 120 (e.g., based on software 124 stored on memory 122) and/or by other components of the device 112 in hardware, software, or a combination of hardware and/or software. In some embodiments, mobile device 112 may comprise, for example, a telephone, a smartphone, a tablet computer, a laptop computer, a GPS, a pocket organizer, a handheld device, or other device comprising the components and functionality described herein.

The processor 120 is an intelligent hardware device, e.g., a central processing unit (CPU) such as those made by Intel® Corporation or AMD®, a microcontroller, an application specific integrated circuit (ASIC), etc. The memory 122 includes non-transitory storage media such as random access memory (RAM) and read-only memory (ROM). The memory 122 stores the software 124 which is computer-readable, computer-executable software code containing instructions that are configured to, when executed, cause the processor 120 to perform various functions described herein. Alternatively, the software 124 may not be directly executable by the processor 120 but is configured to cause the computer, e.g., when compiled and executed, to perform the functions.

The sensor(s) 130 may comprise any type of sensor known in the art. For example, SPS sensors, speed sensors, biometric sensors, temperature sensors, clocks, light sensors, volume sensors, wi-fi sensors, or wireless network sensors. In some embodiments, sensor(s) 130 may comprise virtual sensors, for example, one or more sensors and logic associated with those sensors. In some embodiments, these multiple sensors, e.g. a Wi-Fi sensor, an SPS sensor, and a motion sensor, and logic associated with them may be packaged together as a single sensor 130.

The I/O devices 126 comprise any type of input output device known in the art. For example, a display, speaker, keypad, touch screen or touchpad, etc. I/O devices 126 are configured to enable a user to interact with software 124 executed by processor 120. For example, I/O devices 126 may comprise a touch-screen, which the user may use to update a calendar program running on processor 120.

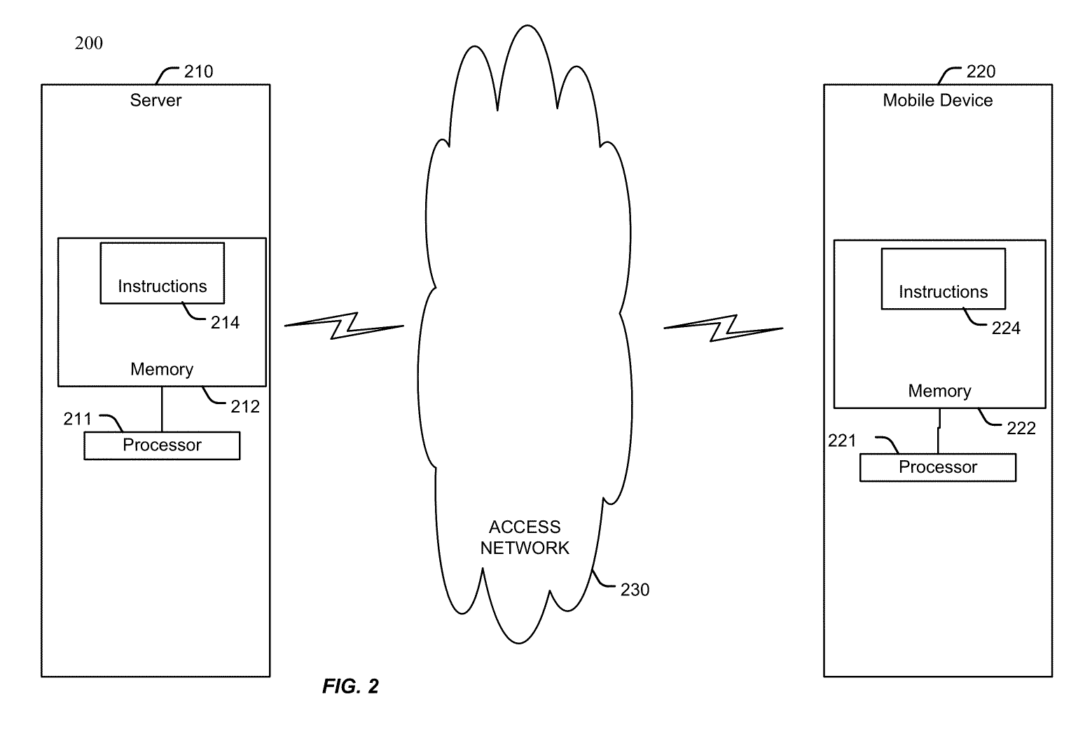

Referring now to FIG. 2, which is one embodiment of a system 200 operable to perform a Dynamic Subsumption Inference. The system 200 includes a server 210 communicably coupled to a mobile device 220 via one or more access networks (e.g., an illustrative access network 230) and possibly also via one or more transit networks (not shown in FIG. 2). In a particular embodiment, the access network 230 may be a Code Division Multiple Access (CDMA) network, Time Division Multiple Access (TDMA) network, Frequency Division Multiple Access (FDMA) network, Orthogonal FDMA (OFDMA) network, Single-Carrier FDMA (SC-FDMA) network, etc. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). The LTE Positioning Protocol (LPP) is a message format standard developed for LTE and that defines the message format between a mobile device and the location servers that have been commonly used in A-GPS functionality.

The server 210 may include a processor 211 and a memory 212 coupled to the processor 211. In a particular embodiment, the memory 212 may store instructions 214 executable by the processor 211, where the instructions represent various logical modules, components, and applications. For example, the memory 212 may store computer-readable, computer-executable software code containing instructions that are configured to, when executed, cause the processor 211 to perform various functions described herein. The memory 212 may also store one or more security credentials of the server 210.

The mobile device 220 may include a processor 221 and a memory 222 coupled to the processor 221. In a particular embodiment, the memory 222 stores instructions 224 executable by the processor 221, where the instructions may represent various logical modules, components, and applications. For example, the memory 222 may store computer-readable, computer-executable software code containing instructions that are configured to, when executed, cause the processor 211 to perform various functions described herein. The memory 222 may also store one or more security credentials of the mobile device 220.

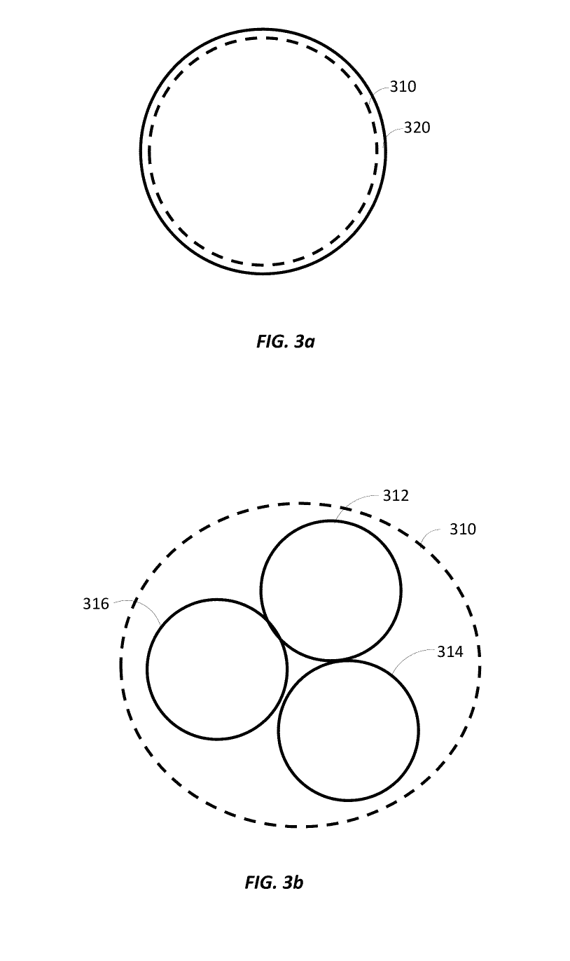

Turning now to FIG. 3a, which is a diagram representation of the potential mismatch between a user's perception of a location 310 and a SPS perception of a location 310, as shown in FIG. 3a, the location 310 may comprise for example, a home. In such an embodiment an SPS engine on a mobile device may determine location information (such as latitude, longitude, and uncertainty) that map to a single label. Thus, the context engine may recognize a location 320 as home based on a one-to-one mapping between the SPS location information and the label “home,” which substantially overlaps with the user's perception of this location 310. Thus, there is substantially perfect overlap between the machine and the human perception of this location. Such an embodiment may not require a substantial inference, i.e., the machine can determine the user is at the specific location from a single type of sensor signals. For example, in the embodiment shown in FIG. 3a, an SPS or wi-fi location system indicating the user is at home. But many other locations may comprise one or more sub-locations, e.g. rooms within a house or buildings within a campus. Thus, in some embodiments, a context engine must make additional calculations to determine a user's location.

Turning now to FIG. 3b, which is a diagram representation of a location 310 that comprises more than one sub-location 312, 314, and 316, and the difference in the user's perception and the machine's perception of this location. For example, as shown in FIG. 3b, again a user's perception of a location is shown as 310. For example, in one embodiment, the user may associate the location with the label “campus.” But through received sensor signals, for example SPS or wi-fi signals, the device recognizes three different locations 312, 314, and 316 associated with three different labels (e.g., dorm 312, athletic building 314, and engineering building 316). But in such an embodiment, the device may not associate the user label “campus” 310 with these three more narrow labels 312, 314, and 316. Thus, in the embodiment above, the device labels for dorm 312, athletic building 314, and engineering building 316 are mismatched with the user's perception of campus 310.

In the embodiment shown in FIG. 3b, 310 subsumes the three labels associated with locations 312, 314, and 316. In such an embodiment, the device may interpret sensor signals as indicating only the more narrow locations within 310. In such an embodiment, the device may not recognize that these locations are in fact part of 310. That is, the user label of location 310 is not associated with the three locations 312, 314, and 316. Thus, a context engine is needed to make the determination that the three labels associated with locations 312, 314, and 316 are subsumed within 310. For example, in the embodiment discussed above, a campus 310 subsumes the more narrow context for, a dorm 312, an athletic building 314, or an engineering building 316.

The embodiment shown in FIG. 3b introduces the concept of subsumption. As shown in FIG. 3b, there are multiple sub-contexts (e.g. a dorm 312, an athletic building 314, or an engineering building 316) that are all subsumed by a larger context (e.g. campus 310). Embodiments disclosed herein describe making determinations based on other sensor information regarding sub-contexts as parts of a larger context. These determinations may be based on information received from various sources, for example, signals received from sensor(s) 130, I/O devices 126 shown in device 112 in FIG. 1, and/or other sources.

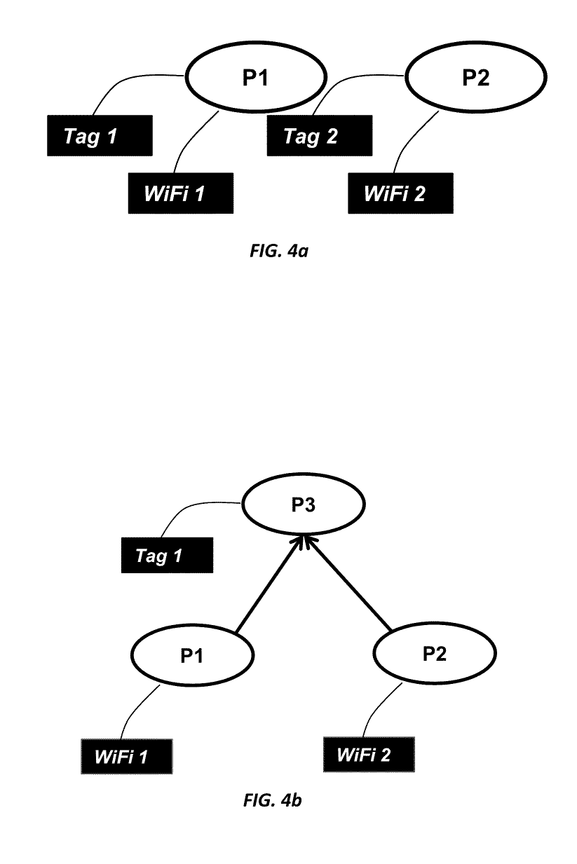

Turning now to FIG. 4a, which is a diagram representation of tags applied based on input data. For example, as shown in FIG. 4a, in one embodiment, a device may be in a location P1, and, while there, detect a signal WiFi 1, which may comprise a location signal or a signal associated with a wireless network. In such an embodiment, the device may further receive Tag 1, which may comprise a signal received from an input device or sensor. Based on Tag 1, the device may make a determination regarding P1. For example, in some embodiments, based on a Tag 1, the device may determine that P1 is a specific location. For example, in one embodiment, the device may determine that P1 is the user's office. In some embodiments, Tag 1 may comprise a tag applied by the user in response to a prompt. For example, in some embodiments, a device may generate a prompt requesting that the user identify a location when the device comes in range of WiFi 1. In other embodiments, Tag 1 may comprise different information. For example, in some embodiments, Tag 1 may comprise a specific time of day, for example, a time when the user is generally working. In such an embodiment, based on this information the device may determine the user is at work. In other embodiments, Tag 1 may be associated with other sensor information, for example, information associated with sounds, light, or other factors, and based on that information, make a determination regarding location P1.

Similarly, as shown in FIG. 4a, based on Tag 2 and WiFi 2, in some embodiments, a device may make a second determination regarding a location P2. In some embodiments, as with Tag 1, Tag 2 may be based on a variety of available sensor or user input information.

Turning now to FIG. 4b, which is a diagram of a subsumption determination made based on Tag 1 and Tag 2. As shown in FIG. 4b, in some embodiments, the device may further determine that Tag 1 and Tag 2 are equivalent. For example, in some embodiments, the user may apply the same tag to both Tag 1 and Tag 2 (e.g. in response to a user prompt). Or, in another embodiment, Tag 1 and Tag 2 may be different, for example, they may be from different sensors. But in some embodiments, the device may make a determination that each tag is equivalent. For example, based on past information received from sensor(s) 130 or I/O devices 126 and stored in memory 122, shown as a component of device 112 in FIG. 1, the device may make a determination regarding the equivalence of two tags. For example, in one embodiment, Tag 1 may be the time of day, which the device associates with the gym (for example, a user may go to the gym Monday, Wednesday, and Friday). Further, in such an embodiment, Tag 2 may comprise a different type of input signal. For example, Tag 2 may be associated with biometric data associated with the user (e.g. heart rate, body temperature, etc.). In such an embodiment, the device may determine that the user is exercising, and thus associated Wi-Fi 2 with the gym as well. In such an embodiment, as shown in FIG. 4b, Tag 1 and Tag 2 are combined, and locations P1 and P2 are subsumed into a higher level of abstraction, into location P3. Thus, for example, in the embodiment described above, location P3 may comprise the gym, and locations P1 and P2 may comprise the weight room and cardio room respectively.

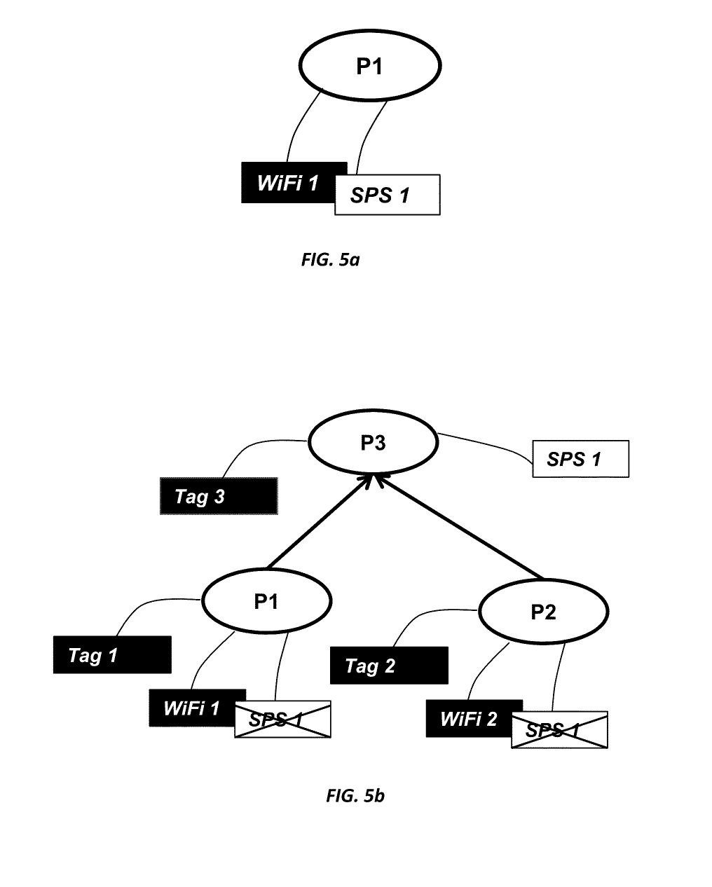

Turning now to FIG. 5a, which is a diagram of location signals available at a specific location. In the embodiment shown in FIG. 5a, the device at location P1 receives one or more Wi-Fi signals Wifi 1 and one or more SPS signals SPS 1. In some embodiments, an SPS-determined location is less precise than a location determined using WiFi signals. For example, multiple rooms in a building may correspond to the same SPS determined location, but be differentiable by the more granular WiFi location determination system. Thus, in the embodiment shown in FIG. 5a, as the user moves within a location SPS 1 changes less frequently than WiFi 1, e.g. as the user moves from room to room in a building WiFi 1 may change, while SPS 1 stays the same.

Turning now to FIG. 5b, which is a diagram explanation of a dynamic subsumption inference according to one embodiment. In the embodiment shown in FIG. 5b, a device may start with a model that is “untrained,” meaning that no tags have been applied to the various received signals. In the embodiment shown in FIG. 5b, there are two locations, P1 and P2. Locations P1 and P2 may comprise two different locations within an office building. For example, in one embodiment, P1 may comprise a conference room and P2 may comprise an office. At each of locations P1 and P2, the device receives two signals. At location P1 the device receives signals WiFi 1 and SPS 1. At location P2, the device receives signals Wifi 2 and SPS 1. In some embodiments, as the user moves from location P1 to location P2 and the signals received by the device change, a tag, Tag 1 or Tag 2 respectively, is applied to each location. For example, in some embodiments, as discussed above, a tag may be applied by the user in response to a prompt. Or in other embodiments, the tag may be applied by the device by monitoring data received from another sensor on the device.

Further, as shown in FIG. 5b, as the user moves from location P1 to location P2, because signal SPS 1 did not change, the device determines a third location P3, which covers both of locations P1 and P2. As this location is determined, the device may apply a new tag, Tag 3, to this location. For example, in the embodiment described above, location P1 may comprise a conference room and P2 may comprise an office, and location P3 may be associated with the label “work.”

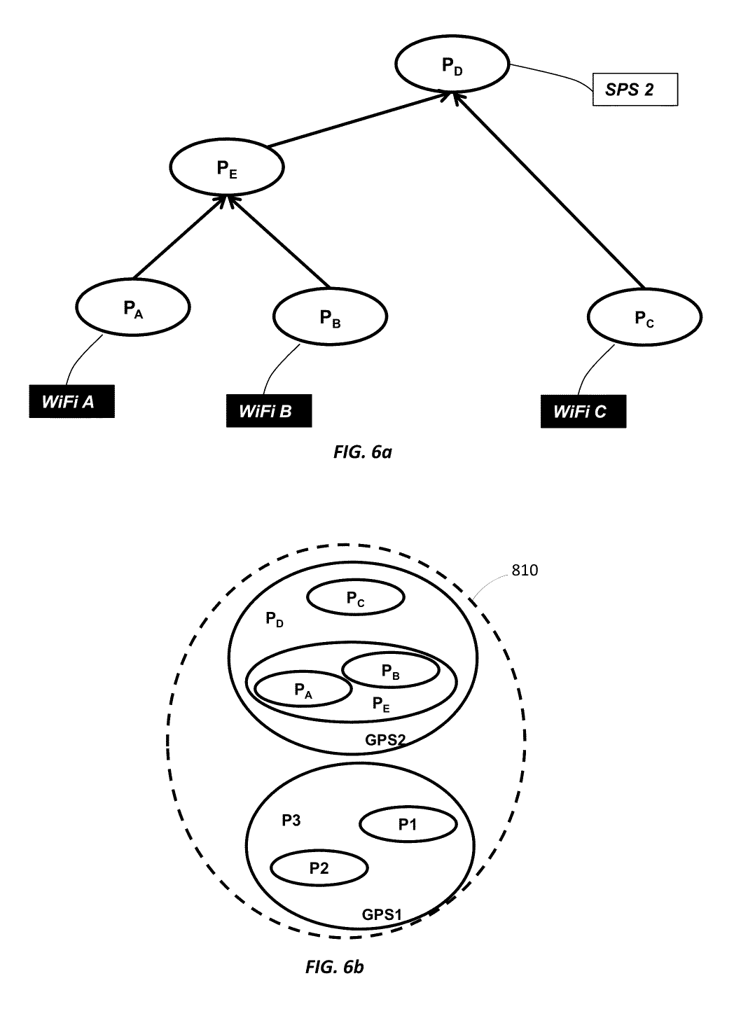

Turning now to FIG. 6a, which is another diagram explanation of a dynamic subsumption inference according to one embodiment. FIG. 6a shows three locations P_{A}, P_{B}, and P_{C}, each of which is associated with a WiFi signal, Wifi A, WiFi B, and WiFi C, respectively. Further, as shown in FIG. 6a, locations P_{A} and P_{B} are subsumed into location P_{E}. This may be determined by tags applied to each location, as discussed in further detail above. Similarly, in the embodiment shown in FIG. 6a, locations P_{E} and P_{C} are each subsumed into Location P_{D}. Further, as shown in FIG. 6a, each location is associated with signal SPS 2. Thus, for example, in the embodiment shown in FIG. 6a, locations P_{A} and P_{B} may be locations such as classrooms within a building P_{E}. And in such an embodiment, location P_{C} may be another building. The building P_{C} and the building P_{E} may further be located on the same campus P_{D}.

Turning now to FIG. 6b, which is another diagram explanation of a dynamic subsumption inference according to one embodiment. FIG. 6b shows an additional abstraction layer, incorporating elements shown in FIGS. 5b and 6a. For example, as shown in FIG. 6b, locations P_{A} and P_{B} are both a part of location P_{E}. For example, in the embodiment described above P_{A} and P_{B} may each be classrooms within a building P_{E}. Similarly, P_{c} may be another building that along with building P_{E} is part of the same campus P_{D}. Further, each of the locations associated with campus P_{D} may be associated with signal SPS2.

Further, as shown in FIG. 6b, locations P1 and P2 are both sub-locations within a larger location P3. For example, in the embodiment described above, location P1 may comprise a conference room and P2 may comprise an office, and location P3 may comprise the complex in which both P1 and P2 are located. Further, in some embodiments, each of the locations within P3 may be associated with the same signal SPS 1. As shown in FIG. 6b, each of locations P3 and P_{D} may be a part of larger area 810. This larger area may, for example, comprise a neighborhood or city, which is associated with both signals SPS 1 and SPS 2.

The examples above are described with regard to locations and signals associated with location determination. But in other embodiments, a context engine may use subsumption to make other determinations based on other signals, for example signals from I/O devices 126, sensor(s) 130, or data stored in memory 122. Thus, in other embodiments, a context engine may build a subsumption model for composites of any type of context and corresponding labels and models. For example, in some embodiments, a user provided label may correspond to multiple machine produced contexts and corresponding models. For example, in some embodiments, labels may be associated with states of mind (e.g. happy, sad, focused, etc.), activities (work, play, exercise, vacation, etc.), or needs of the user (e.g. thirsty, hungry, or searching for something at a store). For example, in some embodiments, a context may be associated with movement in a user's car. In such an embodiment, sensor signals associated with factors such as the user's speed or location, time of day, entries stored in the user's calendar application, posts to social network, or any other available data, may be used by a context engine to make inferences regarding the user's context. For example, in one embodiment, if the context engine receives location signals indicating that the user is near several restaurants at the time of day the user normally eats, then the context engine may determine a context associated with the user searching for a restaurant. Similarly, in another embodiment, if at the same time the user is still in the office and the user continues to be in the office well past the time the user normally eats, then the device may determine a context associated with the user being hungry. In either of these embodiments, the device may further provide the user with menus from nearby restaurants.

In further embodiments, still other factors may be considered. For example, in some embodiments, the context engine may make determinations based on sensor signals associated with the user's activity. For example, in some embodiments, the context engine may associate different activities with different locations within the same larger location. For example, in one embodiment the context engine may determine a context associated with sitting in the living room, for example, while the user is watching TV. In such an embodiment, the context engine may determine another context associated with sitting while in the kitchen. In such an embodiment, the context engine may determine still another context associated with sleeping in the bedroom. In such an embodiment, even if the context engine cannot determine the user's precise location based on location signals, it may be able to narrow the location based on activity. For example, in the embodiment described above, the context engine may determine that if the user is sitting, the user is likely in one of two rooms.

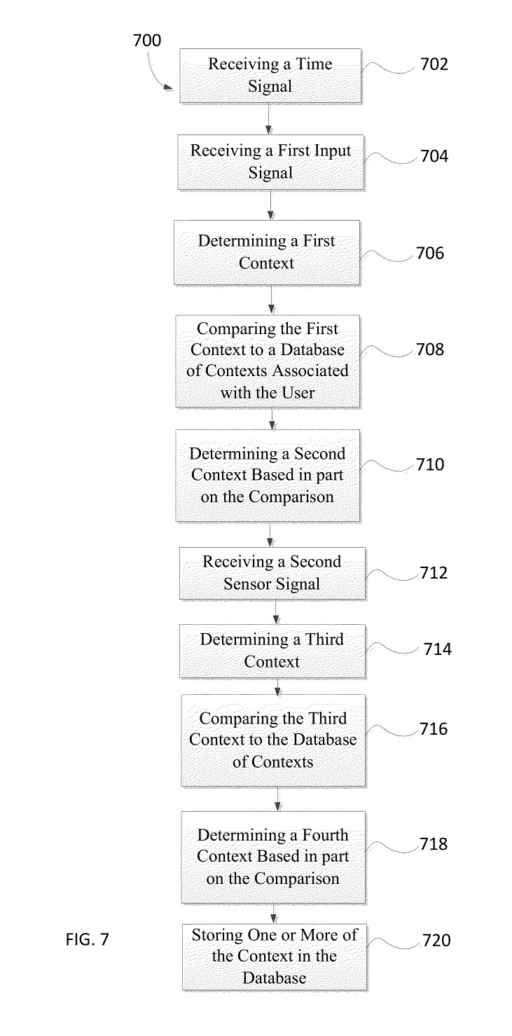

Turning now to FIG. 7, which is a flow chart for a method for dynamic subsumption inference according to one embodiment. In some embodiments, the stages in FIG. 7 may be implemented in program code that is executed by a processor, for example, the processor in a general purpose computer, server, or mobile device, for example, the processor 120 shown in FIG. 1. In some embodiments, these stages may be implemented by a group of processors, for example, a processor 120 on a mobile device 112 and processors on one or more general purpose computers, such as servers. In some embodiments some of the steps in FIG. 7 are bypassed or performed in a different order than shown in FIG. 7.

As shown in FIG. 7, the method 700 starts at stage 702 when a time signal is received. In some embodiments, the time signal may be associated with the current time. In some embodiments, the time signal may be received by processor 120 on mobile device 112 as shown in FIG. 1. In some embodiments a mobile device may comprise a component configured to output accurate time. In other embodiments, processor 120 may comprise an accurate timekeeping function (e.g. an internal clock).

The method 700 continues to stage 704, when a first input signal is received. In some embodiments, the first input signal may comprise data associated with a user at the current time. In some embodiments, the first input signal may be received from one of I/O devices 126, sensor(s) 130, or antenna(s) 128 shown in FIG. 1. For example, in some embodiments, the first input signal may comprise a location signal, e.g., a SPS signal. In other embodiment, the first input signal may comprise input from the user, for example, a response to user prompt. In some embodiments, such response may be referred to as a “tag.” In further embodiments, the first input signal comprises sensor data. For example, in some embodiments, the first input signal may comprise data received from one or more of accelerometers, light sensors, audio sensors, biometric sensors, or other available sensors as known in the art.

Next, at stage 706 a first context is determined In some embodiments, the first context may be determined based on the first input signal and the current time. For example, in some embodiments, the first context may comprise a context associated with the user's current location, e.g., in a specific room. In one embodiment, this specific room may comprise a kitchen. Such a determination may be made based on the first input signal. For example, if the first input signal comprises a location signal, it may indicate the user is in the kitchen. In other embodiments, such a determination may be made on a different type of input signal. For example, in some embodiments, the input signal may comprise an activity signal, which indicates the user is cooking. Further, in some embodiments, a microphone may detect sounds associated with the first room. For example, if the first room is a kitchen, these sounds may be associated with eating, a microwave running, coffee brewing, or some other sound associated with a kitchen. In still other embodiments, the context determination may be based on a light sensor. For example, in one embodiment, a user may be in a dark room. In such an embodiment a light sensor may detect the low level of ambient light, and determine a context associated with sleep or the bedroom.

The method continues to stage 708 when the first context is compared to a database of contexts associated with the user. In some embodiments, the database may be a database stored in memory 122 in FIG. 1. In other embodiments, the database may comprise a remote database stored on a server, for example, a server connected to a device via a data connection.

The method continues to stage 710 when a second context is determined based in part on the comparison discussed in stage 708. In some embodiments the second context comprises a subset of the first context. For example, in some embodiments, the first context may be based on a location signal, for example, a location signal associated with the user's house. In such an embodiment, the database may comprise data indicating that the user normally eats at the current time. In such an embodiment, the device may determine a second context associated with the kitchen.

The method continues at stage 712 when a second input signal is received. As with the first input signal, in some embodiments, the second input signal may comprise data associated with a user at the current time. In some embodiments, the first input signal may be received from one of I/O devices 126, sensor(s) 130, or antenna(s) 128 shown in FIG. 1.

Next, at stage 714 a third context is determined In some embodiments, the third context may be based on the second input signal and the current time. For example, in some embodiments, the first context may be associated with the user's current location, e.g., at work. In such an embodiment, the database may indicate that the user normally has a meeting at the current time, thus the second context may be associated with a meeting. Further the second input signal may be associated with data input on the user's calendar application. In such an embodiment, the calendar application may indicate that the user has a conference call scheduled at the current time. Thus, the third context may be associated with a conference call at the office.

The method continues to stage 716 when the third context is compared to a database of contexts associated with the user. In some embodiments, the database may be a database stored in memory 122 in FIG. 1. In other embodiments, the database may comprise a remote database stored on a server, for example, a server connected to a device via a data connection.

The method continues to stage 718 when a fourth context is determined based in part on the comparison discussed with regard to stage 716. For example, in one embodiment, the first context may be based on a location signal, for example, a location signal associated with the user's house. In such an embodiment the database may comprise data indicating that the user normally eats at the current time. In such an embodiment, the device may determine a second context associated with the kitchen. In such an embodiment, the third input signal may be associated with a post on a social networking site that the user is hungry. Based on this, the third context may be associated with the user being hungry. Further, in such an embodiment, the database may comprise data associated with types of food the user likes. Thus, in such an embodiment, the device may provide the user with menus for nearby restaurants that serve the types of food the user normally likes.

The method continues to stage 720, when one or more of the contexts is stored in a database. In some embodiments, the database may be the same database discussed above with regard to stages 708 and 716. In other embodiments, the database may comprise a different database. In some embodiments, the database may be stored in memory 122 in FIG. 1. In other embodiments, the database may comprise a remote database stored on a server, for example, a server connected to a device via a data connection.

Embodiments of the present disclosure provide numerous advantages. For example, there are oftentimes not direct mappings between user input data and raw device data (e.g. data from sensors). Thus, embodiments of the present disclosure provide systems and methods for bridging the gap between device and human interpretations of data. Further embodiments provide additional benefits, such as more useful devices that can modify operations based on determinations about the user's activity. For example, embodiments of the present disclosure provide for devices that can perform tasks, such as searching for data or deactivating the ringer, before the user thinks to use the mobile device. Such embodiments could lead to wider adoption of mobile devices and greater user satisfaction.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process that is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the disclosure. Also, a number of steps may be undertaken before, during, or after the above elements are considered. Accordingly, the above description does not bound the scope of the claims.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Embodiments in accordance with aspects of the present subject matter can be implemented in digital electronic circuitry, in computer hardware, firmware, software, or in combinations of the preceding. In one embodiment, a computer may comprise a processor or processors. The processor comprises or has access to a computer-readable medium, such as a random access memory (RAM) coupled to the processor. The processor executes computer-executable program instructions stored in memory, such as executing one or more computer programs including a sensor sampling routine, selection routines, and other routines to perform the methods described above.

Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example tangible computer-readable media, that may store instructions that, when executed by the processor, can cause the processor to perform the steps described herein as carried out, or assisted, by a processor. Embodiments of computer-readable media may comprise, but are not limited to, all electronic, optical, magnetic, or other storage devices capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. Also, various other devices may include computer-readable media, such as a router, private or public network, or other transmission device. The processor, and the processing, described may be in one or more structures, and may be dispersed through one or more structures. The processor may comprise code for carrying out one or more of the methods (or parts of methods) described herein.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed is:

1. A method comprising:
receiving a time signal associated with a current time;
receiving a first input signal comprising data associated with a user at the current time;
determining a first context based on the first input signal and the current time;
comparing the first context to a database of contexts associated with the user; and
determining a second context based in part on the comparison.

2. The method of claim 1, wherein the second context is used to modify operation of a mobile device.

3. The method of claim 2, wherein modifying operation of the mobile device comprises directing marketing to the user.

4. The method of claim 1, further comprising:
receiving a second input signal associated with the user at the current time; and
determining a third context based on the second input signal and the current time.

5. The method of claim 4, further comprising:
comparing the third context to the database of contexts associated with the user; and
determining a fourth context based in part on the comparison.

6. The method of claim 1, further comprising storing one or more of the contexts in the database.

7. The method of claim 1, wherein the first input signal comprises a tag applied by the user to a context.

8. The method of claim 1, wherein the first input signal comprises data associated with one or more of: a social networking site, the user's location, or the user's current velocity.

9. The method of claim 1, wherein the first context is a subset of the second context.

10. The method of claim 1, wherein determining the second context comprises comparing the first context to one or more past contexts associated with a similar time of day.

11. A system comprising:
a sensor configured to detect data associated with a user;
a database of contexts associated with the user;
a processor configured to:
receive a time signal associated with a current time;
receive, from the sensor, a input signal comprising data associated with the user;
determine a first context based on current time and the input signal;
compare the first context to a database of contexts associated with the user; and
determine a second context based in part on the comparison.

12. The system of claim 11, wherein the processor is further configured to modify operation of the mobile device based on the second context.

13. The system of claim 12, wherein modifying operation of the mobile device comprises directing marketing to the user.

14. The system of claim 11, wherein the processor is further configured to:
receive a second input signal associated with the user at the current time; and
determine a third context based on the second input signal and the current time.

15. The system of claim 14, further comprising:
comparing the third context to the database of contexts associated with the user; and
determining a fourth context based in part on the comparison.

16. The system of claim 11, wherein the processor is further configured to store one or more of the contexts in the database.

17. The system of claim 11, wherein the first input signal comprises a tag applied by the user to a context.

18. The system of claim 17, wherein the first input signal comprises data associated with one or more of: a social networking site, the user's location, or the user's current velocity.

19. The system of claim 11, wherein the first context is a subset of the second context.

20. The system of claim 11, wherein determining the second context comprises comparing the first context to one or more past contexts associated with a similar time of day.

21. A system comprising:
means for receiving a time signal associated with a current time;
means for receiving a first input signal comprising data associated with a user at the current time;
means for determining a first context based on the first input signal and the current time;
means for comparing the first context to a database of contexts associated with the user; and
means for determining a second context based in part on the comparison.

22. The system of claim 21, wherein the second context is used to modify operation of a mobile device.

23. The system of claim 22, wherein modifying operation of the mobile device comprises directing marketing to the user.

24. The system of claim 21, further comprising:
means for receiving a second input signal associated with the user at the current time; and
means for determining a third context based on the second input signal and the current time.

25. The system of claim 24, further comprising:
means for comparing the third context to the database of contexts associated with the user; and
means for determining a fourth context based in part on the comparison.

26. The system of claim 21, further comprising a means storing one or more of the contexts in the database.

27. The system of claim 21, wherein the first input signal comprises a tag applied by the user to a context.

28. The system of claim 21, wherein the first input signal comprises data associated with one or more of: a social networking site, the user's location, or the user's current velocity.

29. The system of claim 21, wherein the first context is a subset of the second context.

30. The system of claim 21, wherein determining the second context comprises comparing the first context to one or more past contexts associated with a similar time of day.

31. A system comprising a non-transitory computer readable medium comprising processor executable source code configured, when executed to cause a processor to:
receive a time signal associated with a current time;
receive a first input signal comprising data associated with a user at the current time;
determine a first context based on the first input signal and the current time;
compare the first context to a database of contexts associated with the user; and
determine a second context based in part on the comparison.

32. The system of claim 31, wherein the second context is used to modify operation of a mobile device.

33. The system of claim 32, wherein modifying operation of the mobile device comprises directing marketing to the user.

34. The system of claim 32, wherein the processor executable source code is further configured, when executed to cause the processor to:
receive a second input signal associated with the user at the current time; and
determine a third context based on the second input signal and the current time.

35. The system of claim 34, wherein the processor executable source code is further configured, when executed to cause the processor to:
compare the third context to the database of contexts associated with the user; and
determine a fourth context based in part on the comparison.

36. The system of claim 31, wherein the processor executable source code is further configured, when executed to cause the processor to store one or more of the contexts in the database.

37. The system of claim 31, wherein the first input signal comprises a tag applied by the user to a context.

38. The system of claim 31, wherein the first input signal comprises data associated with one or more of: a social networking site, the user's location, or the user's current velocity.

39. The system of claim 31, wherein the first context is a subset of the second context.

40. The system of claim 31, wherein determining the second context comprises comparing the first context to one or more past contexts associated with a similar time of day.
